(19) United States
(12) Patent Application Publication
(10) Pub. No.: US 2012/0254979 A1
(43) Pub. Date: Oct. 4, 2012

(54) UNATTACKABLE HARDWARE INTERNET PACKET PROCESSING DEVICE FOR NETWORK SECURITY

(75) Inventors: Jung tae LEE, Busan (KR); Bong Jun HUR, Seoul (KR); June woo RYU, Seongnam-si (KR); Jae ho LEE, Seongnam-si (KR); Soo hwan KIM, Yongin-si (KR); Young su LEE, Seongnam-si (KR)

(73) Assignee: WIZNET CO., LTD., Seongnam-si (KR)

(21) Appl. No.: 13/244,524

(22) Filed: Sep. 25, 2011

(30) Foreign Application Priority Data
Nov. 10, 2010 (KR) 10-2010-0111443

(51) Int. Cl. G06F 21/00

(52) U.S. Cl. 726/13

(57) ABSTRACT

Hardware internet packet processing device for network security constructed in such a manner that packet data is packet processed by hardware without a receiving memory or MCU and interruption of internet packets for network security is implemented by hardware construction.

### RELATED APPLICATIONS

This application claims priority under 35 U.S.C. 119(a) from Korean Patent Application No. 10-2010-0111443, filed Nov. 10, 2010 in the Korean Intellectual Property Office, which is incorporated herein by reference in its entirety.

### TECHNICAL FIELD

An exemplary embodiment of the present invention to an unprogrammable internet packet processing device which makes malicious network attack inherently impossible, and more specifically, a hardware internet packet processing device for network security which makes it possible to interrupt widely various network attacks by providing an Ethernet packet processing structure in which there is no memory space where malicious code can act.

### BACKGROUND ART

In general, a firewall is arranged in each host in order to interrupt attacks on network traffic, or a software-based or a hardware-based interruption system is arranged in order to preemptively prevent attacks on the network in a level of gateway.

A related art regarding interruption of network attack is proposed in Korean Patent Application No. 10-2009-0009546 titled “device for interrupting attack packet, multi-media communication device with a function of interrupting attack packet and router”, wherein the multi-media communication device (for example, VoIP, video communication) is configured to analyze IP, port information of the counterpart and receivable information and the like and detect and interrupt the attack packet.

Such an approach has a disadvantage that it can defend only attacks on the multi-media communication device and cannot defend the attack when a certified communication counterpart maliciously distributes malicious code etc. Such an approach is strong to a flooding attack but cannot cope with an attack such as a stack overflow attack.

According to Korean Patent Application No. 10-2002-0075180 titled “method for preventing stack overflow in a level of kernel in operation system of a computer”, a stack overflow attack is prevented by excluding a stack region from an execution code region of the kernel of the operation system. Return code which must be processed in the stack are copied to the execution code region which can execute the relevant return code. Furthermore, in the case that the code must be executed in the stack, a general protection default trap is caused to be produced in the kernel by hardware and then detects the execution in the stack, and in this case the execution instruction address is checked, and if the address is for a stack region, an error occurs.

However, such an approach has problems in that additional function software needs to be embodied which detects and defends against the attack while concentrating on defending a stack overflow attack, and in the embodiment a portion of system resources is consumed and a network traffic attack such as packet flooding attack, injection attack, DDoS attack etc. cannot be coped with. Further this approach has a disadvantage in that it cannot be utilized in an environment without an OS.

According to Korean Patent Application No. 10-2004-0018279 titled “method and device for detecting and recovering buffer overflow attacks”, a return address is checked for all of process return commands by utilizing the fact that execution in the stack is indispensable due to a nature of the buffer overflow attacks, and then the attack is detected and interrupted when the return address is in the range of the stack overflow after execution in the stack, which likewise applies to storage commands. Furthermore, a separate recovering buffer is provided and can recover a portion damaged by overflow attack.

However, there are disadvantages in that it is relatively complex in its embodiment and performance of the system is expected to be degraded, and since the recovering buffer is separately provided, the buffer is a burden on the system as a size of the buffer is enlarged, and also a traffic attack cannot be coped with.

Furthermore, Korean Patent Application No. 10-2004-0009684 titled “network security system and method of operating thereof” discloses a method of interrupting the network attack by means of hardware filtering against a static attack of network traffic and software filtering against a dynamic attack, wherein malicious code is updated by providing a separate server so that the software filtering information can be shared by nodes on the network.

However, while this approach is strong to a network traffic attack, it has a disadvantage that it is vulnerable to a malicious code attack such as hacking attacks and stack overflow attacks and a separate exchange of malicious code information is necessary for the software filtering.

In the above-mentioned approaches, technologies for network security can be broadly classified into a hardware type, software type and a combination type of the hardware and software types.

FIG. 1 is a schematic representation of a prior software-type network defense. As illustrated in this figure, there is provided a receiving memory (1) for storing packet information received from a network, a TCP/IP processing part (2) for implementing a software TCP/IP process for packet data stored in the receiving memory (1), and attack defending code (3) for determining whether the network is attacked or not by checking all return addresses of executing code of a software stack in processing of TCP/IP by the TCP/IP processing part (2), whereby a code attack is interrupted with software in processing of the TCP/IP and received data of an embedded system (4) is sent and received.

Such a method using the software is one for preventing the attack by separately adding codes for detecting malicious codes or attack to a SW stack for processing the packet. A typical method for preventing the stack overflow attack is one that confirms the attacks by checking all the return addresses of executing code of SW stack.

However, there is a disadvantage in that such an approach is vulnerable to a network traffic attack and also packet processing rate is decreased.

FIG. 2 is a schematic representation of a prior hardware-type network defense. As illustrated in this figure, installed in front of the receiving memory (1) is a hardware filter (5) for filtering and interrupting IP addresses or port numbers or MAC addresses etc. received from the network, and packet of the receiving memory (1) is processed in the software TCP/IP processing part (2) and sent to the embedded system (4).

The most widely used method of such a hardware type is one where a hardware (HW) filter (5) is provided in a receiving stage. There is a basic method where IP addresses or port numbers or MAC addresses etc. are filtered and then interrupted, and a method where packets having specific patterns are interrupted.

However, the above-mentioned prior hardware type is not suitable for defending against a malicious code attack such as a stack overflow attack.

FIG. 3 is a schematic representation of a combination type network defense combining prior hardware and software types of network defense. As illustrated in this figure, construction is such that the hardware filter (5) in FIG. 2 is added to the software type of FIG. 1, which construction has a good attack defending ability, but is ineffective in view of cost and processing rate.

### SUMMARY

Taking into account the above-mentioned problems of the prior art, an exemplary embodiment of the present invention aims at providing a network security hardware internet packet processing device which makes it possible to fundamentally interrupt activities of the malicious codes by utilizing internet packet processing structure where there are no memory spaces in which malicious code can act.

An exemplary embodiment of the present invention further aims at providing a network security hardware internet packet processing device which makes it possible to process internet packets sent from the network in real time without a separate data memory by utilizing a parallel data processing structure.

An exemplary embodiment of the present invention aims at defending widely varying network attacks by embodying a H/W attack defensing filter using IP, port, MAC information in such a manner that the network traffic attacks such as a flooding attack, a spoofing attack and an injection attack can be interrupted by providing a hardware internet packet processing device.

The above-mentioned hardware internet packet processing device for network security of an exemplary embodiment of the present invention may include:

a parallel data bus for parallel processing input internet packet data;

a hardware packet processing device which receives the input internet packet data through the parallel data bus and then hierarchically controls processing of an Ethernet packet, processing of an IP packet, processing of a UDP packet and processing of a TCP packet according to a protocol of internet packet control information and also a shutoff packet determined as network invasion information on the basis of filtering result information; and

a hardware filter device which is constructed in parallel with said hardware packet processing device and receives the input internet packet data through the parallel data bus and filters the input internet packet data through Ethernet filter, IP filter, UDP filter and TCP filter on the basis of filter control information previously set for packet interruption and then sends the filtering result information to the hardware packet processing device. The hardware packet processing device may be constructed in such a manner that the input internet packet data is packet processed by hardware without a receiving memory or MCU and interruption of internet packet data for network security is controlled.

Said hardware packet processing device may comprise:

a packet processing part which includes an Ethernet packet processing unit, an IP packet processing unit, a UDP packet processing unit and a TCP packet processing unit and classifies packet control information from the received input internet packet data to send packet data to a user's system and hierarchically process the packets; and

a packet processing controller which receives the packet control information from the packet processing part and then controls the Ethernet packet processing unit, the IP packet processing unit, the UDP packet processing unit and the TCP packet processing unit according to protocol determination so as to hierarchically process the packets, and interrupts processing of packet by the relevant packet processing part so as to interrupt the shutoff packet determined as network invasion information on the basis of the filtering result information received from said hardware filter device.

Said hardware filter device may comprise:

a filter part which is constructed in parallel with said hardware packet processing device, receives the internet packet data from the parallel data bus and then implements the filtering through an Ethernet packet filter, an IP packet filter, a UDP packet filter and a TCP packet filter on the basis of filter control information; and

a filter controller in which ping blocking, a port number, a MAC address and an IP address are set as the filter control information of said filter part and which provides each filter of the filter part with the relevant filter control information and send the filtering result information of each filter of the filter part to said packet processing controller.

Said packet processing controller may comprise:

a packet control part which receives packet information from said packet processing part and then hierarchically controls enabling and disabling of each packet processing unit on the basis of the protocol and controls processing of an internet packet;

a filter result information receiving part for receiving the filter result information from said filter controller;

an packet interruption control part which implements packet interruption control through said packet processing part so as to interrupt a corresponding packet on the basis of the filter result information received through said filter result information receiving part;

an interrupted packet filter control information detecting part which detects network information regarding the interrupted packet from said packet control part to produce it as filter control information; and

a filter control information sending part which sends the filter control information produced in said interrupted packet filter control information detecting part to said filter controller to update the filter control information.

Said filter controller may comprise:

a filter control information setting part which sets the ping blocking, the port number, the MAC address, the IP address and pattern information to be filtered and controls an updating process on the basis of the filter control information received from said packet processing controller;

a filter control information storing part which updates, stores and sets the filter control information controlled by said filter control information setting part;

a filter control part which sends the filter control information stored in said filter control information storing part to said filter part; and

a filtering result information sending part which detects the filtering result information of the filter part through said filter control part to send it to said packet processing controller as the filtering result information for packet interruption.

If the internet packet processing device of an exemplary embodiment of the present invention is applied, an operation system may not be present and a receiving memory may not be necessary because all processes may be performed in real time by the hardware, and therefore there may be no room for the stack overflow attack to occur. Furthermore, likewise another malicious code attack may be impossible because of such a hardware structure that there is no storage space from the very beginning where the malicious code may be stored and executed.

Furthermore, in the case of a network traffic attack (ex: Snooping, a Flooding attack), a main user of upper level of the internet packet processing device does not cope with the ARP, ICMP flooding attack, since the internet packet processing device of an exemplary embodiment the present invention automatically copes with it, and the system of the main user is not overloaded.

The foregoing and other aspects will become apparent from the following detailed description when considered in conjunction with the accompanying drawing figures.

### BRIEF DESCRIPTION OF THE DRAWING

FIG. 1 is a schematic representation of a prior software-type network defense.

FIG. 2 is 1 is a schematic representation of a prior hardware-type network defense.

FIG. 3 is a schematic representation of a combination type network defense combining the prior software and hardware types of network defense.

FIG. 4 is a schematic representation of a hardware-type internet packet processing device according to an exemplary embodiment of the present invention.

FIG. 5 is a schematic representation of a construction of a hardware internet packet processing device for network security according to an exemplary embodiment of the present invention.

FIG. 6 is a schematic representation of a construction of a packet processing controller according to an exemplary embodiment of the present invention.

FIG. 7 is a schematic representation of a construction of a filter controller according to an exemplary embodiment of the present invention.

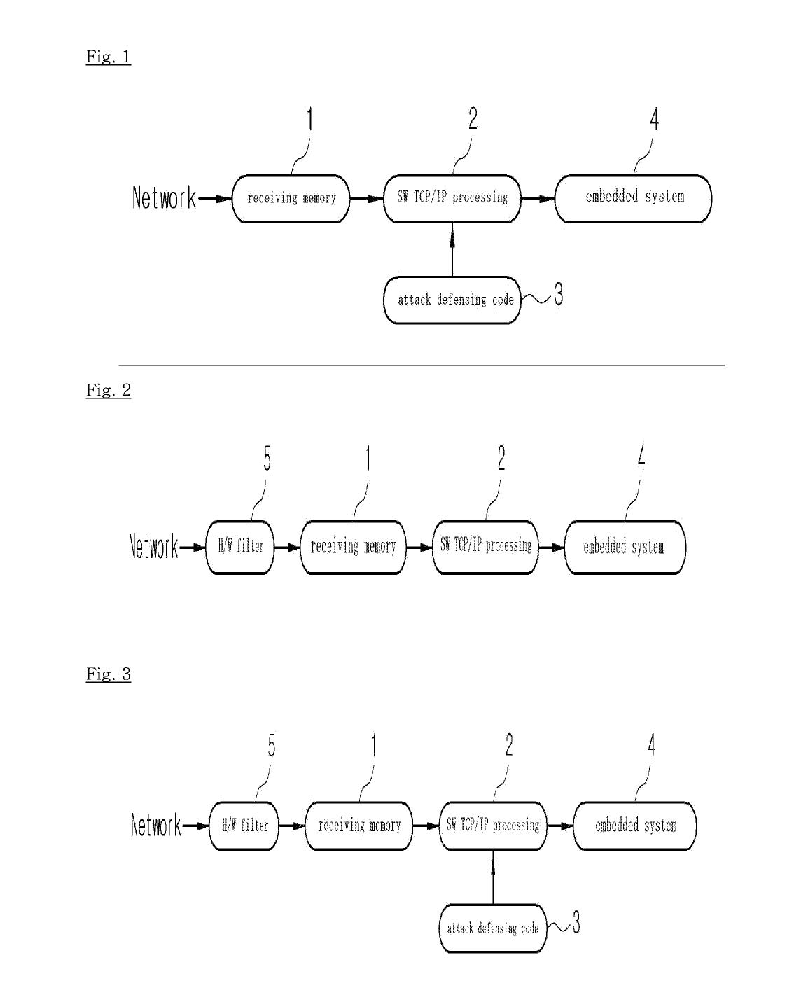

### DETAILED DESCRIPTION

Reference will now be made in detail to exemplary embodiments of the present invention, examples of which are illustrated in the accompanying drawings, wherein like reference numerals refer to the like elements throughout. The exemplary embodiments are described below to explain the present invention by referring to the figures.

As used in the description of this application, the terms “a”, “an” and “the” may refer to one or more than one of an element (e.g., item or act). Similarly, a particular quantity of an element may be described or shown while the actual quantity of the element may differ. The terms “and” and “or” may be used in the conjunctive or disjunctive sense and will generally be understood to be equivalent to “and/or”. References to “an” or “one” embodiment are not necessarily all referring to the same embodiment. Elements from an embodiment may be combined with elements of another. No element used in the description of this application should be construed as critical or essential to the invention unless explicitly described as such. Further, when an element is described as “connected,” “coupled,” or otherwise linked to another element, it may be directly linked to the other element, or intervening elements may be present.

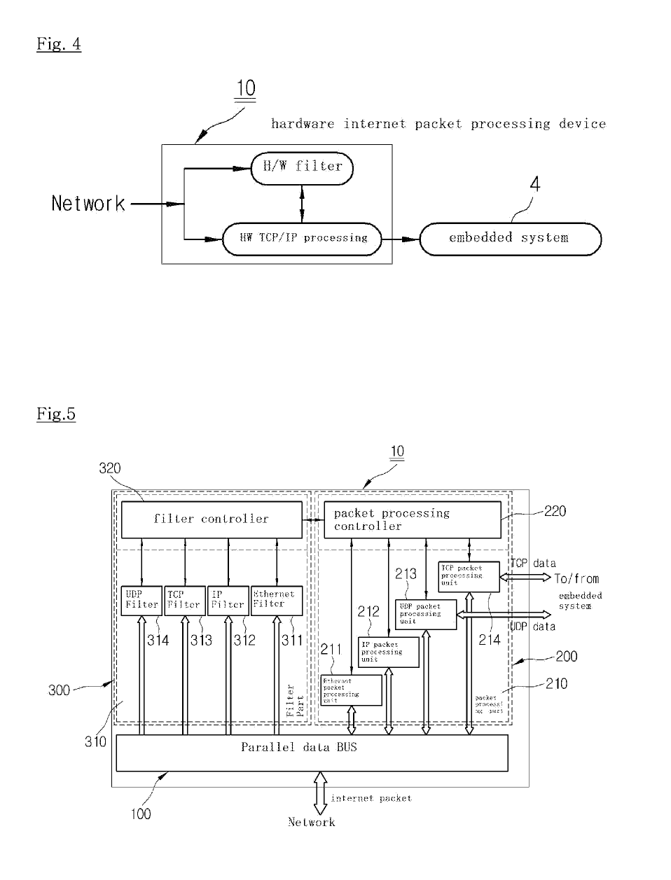

FIG. 4 is an schematic representation of a hardware-type internet packet processing device according to an exemplary embodiment of the present invention.

As illustrated in the figure, in the exemplary embodiment of the present invention, the internet packet processing device (10) for network security may be constructed by connecting a hardware filter device (300) and a hardware packet processing device (200) for processing the hardware Transport Control Protocol/Internet Protocol (TCP/IP) to an external network in parallel. That is to say, the exemplary embodiment of the present invention provides an internet packet processing device which may receive and send internet packet data while performing internet security processing without a receiving memory or Microcontroller Unit (MCU).

FIG. 5 is a schematic representation of a construction of a internet packet processing device for network security according to an exemplary embodiment of the present invention. As illustrated in this figure, the hardware internet packet processing device may comprise:

a parallel data bus (100) for parallel processing input internet packet data;

a hardware packet processing device (200) which may receive the input internet packet data through the parallel data bus (100) and then may hierarchically control processing of an Ethernet packet, processing of an IP packet, processing of a User Datagram Protocol (UDP) packet and processing of a TCP packet according to protocol of internet packet control information and also a shutoff packet determined as network invasion information on the basis of filtering result information; and

a hardware filter device (300) which may be constructed in parallel with said hardware packet processing device (200) and may receive the input internet packet data through the parallel data bus (100) and may filter the input internet packet data on the basis of filter control information previously set for packet interruption and then may send the filtering result information to the hardware packet processing device (200).

That is to say, the exemplary embodiment of the present invention may be characterized in that it may be constructed in such a manner that the input internet packet data may be packet processed by hardware without a receiving memory or a MCU and interruption of internet packet data for network security is implemented by a hardware construction.

Said hardware packet processing device (200) is may comprise:

a packet processing part (210) which may include an Ethernet packet processing unit (211), an IP packet processing unit (212), a UDP packet processing unit (213) and a TCP packet processing unit (214) and may classify packet control information from the received input internet packet data to hierarchically process packets and send UDP data and TCP data to an embedded system; and

a packet processing controller (220) which may receive the packet control information from the packet processing part (210) and then control the Ethernet packet processing unit (211), the IP packet processing unit (212), the UDP packet processing unit (213) and the TCP packet processing unit (214) according to protocol so as to hierarchically process the packets, and control a relevant unit of the packet processing part (210) so as to interrupt the shutoff packet determined as network invasion information on the basis of the filtering result information received from said hardware filter device (300).

Said hardware filter device (300)may comprise:

a filter part (310) which may be constructed in parallel with said hardware packet processing device (200), and may include an Ethernet packet filter (311), an IP packet filter (312), a TCP packet filter (313) and a UDP packet filter (314) and may receive the input internet packet data from said parallel data bus (100), and may filter the received input internet packet data on the basis of the filter control information; and

a filter controller (320) in which ping blocking, a port number, a MAC, and a IP address may be set as the filter control information of said filter part (310) and which provides each filter of the filter part with the relevant filter control information and controls each filter of the filter part to send the filtering result information to said hardware packet processing device (200).

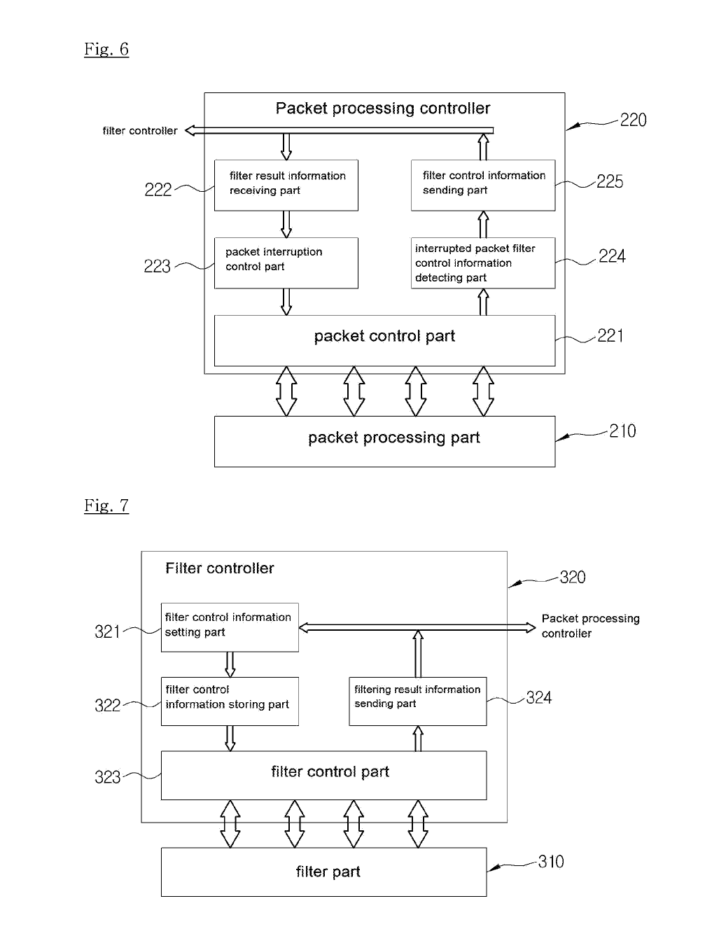

FIG. 6 is a schematic representation of a construction of the packet processing controller (220) according to an exemplary embodiment of the present invention. As illustrated in this figure, the packet processing controller may comprise:

a packet control part (221) which may receive packet information from said packet processing part (210) and may then hierarchically control enabling and disabling of each unit of the packet processing unit on the basis of protocol and may control processing of an internet packet;

a filter result information receiving part (222) for receiving the filter result information from said filter controller (320);

a packet interruption control part (223) which may impellent packet interruption control through said packet processing part (210) so as to interrupt a corresponding packet on the basis of the filter result information received through said filter result information receiving part (222);

an interrupted packet filter control information detecting part (224) which detects network information regarding the interrupted packet from said packet control part (221) to produce it as filter control information; and

a filter control information sending part (225) which sends the filter control information produced in said interrupted packet filter control information detecting part (224) to said filter controller (320) to update the filter control information.

FIG. 7 is a schematic representation of a construction of the filter controller according to an exemplary embodiment the present invention. As illustrated in this figure, said filter controller (320) comprises:

a filter control information setting part (321) which may set the ping blocking, the port number, the MAC address, the IP address and pattern information to be filtered and may control an updating process on the basis of the filter control information received from a packet processing controller (220);

a filter control information storing part (322) which may update, store and set the filter control information controlled by said filter control information setting part (321);

a filter control part (323) which may send the filter control information stored in said filter control information storing part (322) to said filter part (310); and

a filtering result information sending part (324) which may detect the filtering result information of the filter part (310) through said filter control part (323) to send it to said packet processing controller (220) as the filtering result information for packet interruption.

The packet processing part (210) of the hardware packet processing device (200) of an embodiment of the present invention constructed as above may receive the packet information from the parallel data bus (100) to classify only control information necessary for packet control and then send the control information to the packet processing controller (220), and sends the packet data to an upper hierarchy. Then the packet processing part may receive the packet processing control information from the packet processing controller (220) to process a current packet. The processing units of the packet processing part (210) may all be constructed of hardware logic and may not require a receiving memory or buffer because they may process the packets in real time in a unit of 1 Byte.

In the packet processing part (210), the Ethernet packet processing unit (211), the IP packet processing unit (212), the UDP packet processing unit (213) and the TCP packet processing unit (214) may be constructed in a hierarchical structure, and the packet processing part may classify the packet information from the internet packet data received from the parallel data bus (100) and then may send the packet information to the packet processing controller (220), and may process the packets under control of the packet processing controller. Here, the packet processing part constructed of hardware may implement the conventional software packet processing in real time in each packet processing unit constructed of hardware logic, which is embodied in the registered patent of the applicant titled “4-hierarchy switching device using the hardware TCP/IP processing device and method of operating thereof” (Korean Patent Registration No. 0643140) and “communication method enabling high-speed data process for embedded system and device therefor”(Korean Patent Registration No. 0530856), both of which are hereby incorporated by reference in their entirety.

In an embodiment of the present invention, a hardware filter device may be constructed in parallel with the hardware packet processing device described as above and packet interruption may be controlled according to a filtering result regarding the internet packet received in real time. Accordingly, an internet packet under malicious attack and packet corresponding to an IP number, a port number etc. set by the user may be interrupted without a receiving memory temporarily storing the internet packet or a buffer.

The packet processing controller (220) may control the packet process by hierarchically controlling each packet processing unit of the packet processing part (210) according to the protocol of the internet packet information received from said packet processing part (210). In addition the relevant packet may be interrupted by controlling the packet processing part (210) through packet control part (221) in such a manner that the packet interruption controlling part (223) may receive the filter result information from the hardware filter device (300) to interrupt the relevant packet. In this connection, network information of the interrupted packet is extracted from the interrupted packet filter control information detecting part (224) and then sent from the filter control information sending part (225) to the filter controller (320), whereby the filter control information is updated.

That is to say, ping blocking, a port number, a MAC address, an IP address, etc. may be set by the user as the filter control information set in the filter controller (320), and in addition an input pattern of the packet may be filtered. As a result, if a pattern determined as malicious attack is filtered, the relevant packet may be interrupted by the relevant filter information. The IP address or port number where the interrupted packet occurred may be detected in the interrupted packet filter control information detecting part (224) and then stored in the filter control information storing part (322) of the filter controller (320). Henceforth, filtering may be performed for the relevant IP address or port number regardless of filtering of the pattern.

For example, a pattern or port number for a specific application may be defined as internet packet data, and if such a defined pattern is filtered, it can be determined whether the malicious attack is present or not, and the packet is interrupted in which the pattern determined as a malicious attack has occurred, and henceforth the internet packet received through the port number by which the interrupted pattern has been received may be automatically interrupted. That is to say, once a malicious attack pattern is received, the relevant IP address or port number may be inherently interrupted according to analysis of the relevant network information.

Said packet processing controller (220) may be comprised of hardware logic, may receive the packet information from the packet processing part (210) to determine the protocol of the packet, thereby controlling the packet processing part (210), and may control the relevant packet processing part (210) so as to interrupt the packet determined as network invasion on the basis of the filtering result information received from the filter controller (320), and in addition may send the network information regarding the MAC address, IP address, and port number in which the packet is interrupted to said filter controller (320) as the filter control information, and thereby may update the filter control information of the filter control information storing part (322).

That is to say, in the case of packet interruption, the network information of the relevant packet may be sent as the filter control information to the hardware filter device (300). In reverse, the packet interruption control of the packet processing part (210) may be performed by receiving the filtering information from the hardware filter device (300). All of these processes may be comprised of hardware logic circuits and performed in real time.

Said filter controller (320) may previously set ping blocking, a port number, a MAC address, and an IP address as the filter control information so that the user may determine a filtering level, and may send the set filter control information to each relevant filter and may control each filter to compare the filter information and the received internet packet data and then may perform the filtering.

The result information regarding the filtering performed in each filter may be sent to said internet packet-processing part (200), whereby the packet corresponding to the previously set filter control information may be controlled to be interrupted.

Furthermore, the network information such as MAC address, IP address and port number for the packet interrupted from the hardware packet processing device (200) may be received as the filter control information and then added to the filter control information set by the user of said hardware filter device (300) in real time, thereby updating the filter control information. Accordingly, the filter process may be performed on internet packet data received henceforth for the packet automatically interrupted by analysis of the network information (for example, in addition to the filtering information set by the user, as the filter control information, network information of the packet having the pattern which is filtered by setting so that the filtering of basic pattern of internet packet can also be implemented and determined to be interrupted) in addition to the filter control information set by the user. Therefore the relevant internet packet may be automatically interrupted by the network information such as the MAC address, the IP address and the port number which have been maliciously attacked once. Since all may be constructed of hardware logic and processed in real time, a countermeasure on the attack may be taken immediately as soon as the attack occurs.

A method of counteracting malicious code attack (ex: stack overflow attack) by means of an embodiment of the present invention will be described as follows.

Assume a stack overflow and forecast attack-defensing scenario. In the case of a conventional system, the receiving memory is provided and the received internet packet is stored in the stack region and then processed. Operation system (ex: windows, Linux, embedded OS) and memory space may be required so that the code causing the stack overflow attack can be operated. If the operation system comes across stack overflow attack code (a part of the received packet) while securing the stack region and processing the received packet, it returns to address of unintended and odd memory, whereby malicious code intended by the attacker is executed.

It should be noted, if the internet packet-processing device of an embodiment of the present invention is applied, the operation system may not be present and the receiving memory may not be necessary because all processes may be performed in real time by the hardware. Since there may be no more than these two elements, there may be no room for the stack overflow attack to occur. That is to say, if the part of the received packet data intended for the stack overflow attack is met, the attack may not be successful.

Likewise another malicious code attack may be impossible because of such a hardware structure that there may be no storage space from the very beginning where the malicious code is stored and executed.

Also, in the case of a network traffic attack (ex: Snooping, Flooding attack), if a host receives an ARP request packet and an ICMP request packet on the internet, a response must be generally given. A traffic attack is an attack in which more packets than those which can be processed within the host's capacity are sent to the host at a time. In this case, the system of the host is overloaded, whereby there may be a case that its processing ability is decreased or the system is paralyzed.

In contrast, if the host using the internet packet-processing device of an embodiment of the present invention continuously receives the ARP request packet and ICMP request packet, a response packet may be produced automatically in the Ethernet packet processing unit (211) and IP packet processing unit (212) and then sent to the sender. Though a main user of upper level of the internet packet processing device may not cope with the ARP, ICMP flooding attack, since the internet packet processing device of an exemplary embodiment of the present invention may automatically cope with it, the system of the main user is not loaded. If ICMP request packets more than necessary are occurred, the ping blocking controller of the filter controller is set, whereby ICMP packet process may not be performed from the very beginning.

Although embodiments of the present invention have been shown and described, it would be appreciated by those skilled in the art that changes may be made in these embodiments without departing from the principles and spirit of the invention, the scope of which is defined in the claims and their equivalents.

1. A hardware internet packet processing device for network security, comprising:
a parallel data bus for parallel processing input internet packet data;
a hardware packet processing device which receives the input internet packet data through the parallel data bus and then hierarchically controls processing of an Ethernet packet, processing of an Internet Protocol (IP) packet, processing of a User Datagram Protocol (UDP) packet and processing of a Transmission Control Protocol (TCP) packet according to a protocol of internet packet control information and also a shutoff packet determined as network invasion information on the basis of filtering result information; and
a hardware filter device which is constructed in parallel with said hardware packet processing device and receives the input internet packet data through the parallel data bus and filters the input internet packet data on the basis of filter control information previously set for packet interruption and then sends the filtering result information to the hardware packet processing device,
wherein the hardware packet processing device is constructed in such a manner that the input internet packet data is packet processed by hardware without a receiving memory or a Microcontroller Unit (MCU) and interruption of internet packet data for network security is implemented by a hardware construction.

2. The hardware internet packet processing device for network security according claim 1, wherein said hardware packet processing device comprises:
a packet processing part which includes an Ethernet packet processing unit, an IP packet processing unit, a UDP packet processing unit and a TCP packet processing unit and classifies packet control information from the received input internet packet data to hierarchically process packets and send the input internet packet data to an embedded system; and
a packet processing controller which receives the packet control information from the packet processing part and then controls the Ethernet packet processing unit, the IP packet processing unit, the UDP packet processing unit and the TCP packet processing unit according to protocol so as to hierarchically process the packets, and control the a relevant unit of the packet processing part so as to interrupt the shutoff packet determined as network invasion information on the basis of the filtering result information received from said hardware filter device.

3. The hardware internet packet processing device for network security according claim 1, wherein said hardware filter device comprises:
a filter part which is constructed in parallel with said hardware packet processing device, and includes an Ethernet packet filter, an IP packet filter, a TCP packet filter and a UDP packet filter and which receives the input internet packet data from said parallel data bus, and filters the received input internet packet data on the basis of the filter control information; and
a filter controller in which ping blocking, a port number, a MAC address and a IP address are set as the filter control information of said filter part and which provides each filter of the filter part with the relevant filter control information and controls each filter of the filter part to send the filtering result information to said hardware packet processing device.

4. The hardware internet packet processing device for network security according claim 2, wherein said packet processing controller comprises:
a packet control part which receives packet information from said packet processing part and then hierarchically controls enabling and disabling of each unit of the packet processing part on the basis of protocol and controls processing of an internet packet;
a filter result information receiving part for receiving the filter result information from said filter controller;
a packet interruption control part which implements packet interruption control through said packet processing part so as to interrupt a corresponding packet on the basis of the filter result information received through said filter result information receiving part;
an interrupted packet filter control information detecting part which detects network information regarding the interrupted packet from said packet control part to produce it as filter control information; and
a filter control information sending part which sends the filter control information produced in said interrupted packet filter control information-detecting part to said filter controller to update the filter control information.

5. The hardware internet packet processing device for network security according claim 3, wherein said filter controller comprises:
a filter control information setting part which sets the ping blocking, the port number, the MAC address, the IP address and pattern information to be filtered and controls an updating process on the basis of the filter control information received from said packet processing controller;
a filter control information storing part which updates, stores and sets the filter control information controlled by said filter control information setting part;
a filter control part which sends the filter control information stored in said filter control information storing part to said filter part to control filtering of the Ethernet filter, IP filter, TCP filter and UDP filter, and
a filtering result information-sending part which detects the filtering result information of the filter part through said filter control part to send it to said packet processing controller as the filtering result information for packet interruption.
